(19) United States
(12) Patent Application Publication
(10) Pub. No.: US 2014/0030491 A1
(43) Pub. Date: Jan. 30, 2014

(54) FLEXURALLY RIGID LAMINATED SHEETS, PARTS MOLDED THEREFROM AND METHOD OF FABRICATION

(71) Applicants: Hiroshi Sakai, Mie-ken (JP); Hijiri Kita, Mie-ken (JP); Karl-Ludwig Brentrup, Moeriken (CH)

(72) Inventors: Hiroshi Sakai, Mie-ken (JP); Hijiri Kita, Mie-ken (JP); Karl-Ludwig Brentrup, Moeriken (CH)

(73) Assignee: QUADRANT PLASTIC COMPOSITES JAPAN LTD, Mie-ken (JP)

(21) Appl. No.: 13/981,509

(22) PCT Filed: Jan. 25, 2012
(86) PCT No.: PCT/EP2012/051175

§ 371 Date: Oct. 11, 2013

(30) Foreign Application Priority Data
Jan. 25, 2011 (JP) 2011-13164

(51) Int. Cl. B29C 70/08; B32B 5/14; B32B 27/04; B32B 5/06

(52) U.S. Cl. CPC B29C 70/085; B32B 5/06; B32B 5/142; B32B 27/04
USPC 428/172; 428/212; 428/196; 156/91

(57) ABSTRACT

Flexurally rigid molded parts are prepared by stacking a needled nonwoven mat of reinforcing fibers, at least one thermoplastic resin sheet and at least one surface sheet formed of a non-woven cloth comprising cloth fibers. The multilayered sheet obtained in this manner is subjected to heat and pressure followed by cooling under pressure, thereby forming a semi-finished product consisting of a consolidated laminated sheet with a porosity not exceeding 5% by volume. Upon reheating, the main body increases in thickness, thereby forming a porous laminated sheet that can be formed to a compact in a hot molding process.

### CROSS-REFERENCE TO RELATED APPLICATIONS

This application is the U.S. National Phase of PCT Appln. No. PCT/EP2012/051175 filed Jan. 25, 2012 which claims priority to Japanese Application No. 2011-13164 filed Jan. 25, 2011, the disclosures of which are incorporated in their entirety by reference herein.

### BACKGROUND OF THE INVENTION

1. Technical Field

The present invention generally relates to methods for producing flexurally rigid laminated sheets and flexurally rigid molded parts as well as to laminated sheets and molded parts obtained therefrom.

2. Background Art

Fiber mats having increased flexure strength by virtue of being impregnated with thermoplastic resins are generally known, e.g. from JP 2003-080519 (A). However, because glass fibers are exposed on the outer surfaces of such fiber mats, the latter are harsh to the touch. Applying a nonwoven cloth on the outer side of such fiber mats leads to a smooth feel and to a nice appearance. However, there is the problem that the applied nonwoven cloth is easy to peel off from the outer side of the fiber mat. The same disadvantages occur with molded parts made therefrom.

### SUMMARY OF THE INVENTION

It is an object of the present invention to provide improved laminated sheets and molded parts having a main body including fiber mats and at least one surface sheet such as a non-woven cloth for a smooth feel and nice appearance. In particular, the improvement shall result in a better non-detachability of such surface sheets by increasing the adhesive strength of the surface sheet against the outer side of the main body.

The above and further objects are achieved with the methods, molded parts, and with the laminated sheets disclosed herein.

### BRIEF DESCRIPTION OF TH DRAWINGS

The above mentioned and other features and objects of this invention and the manner of achieving them will become more apparent and this invention itself will be better understood by reference to the following description of various embodiments of this invention taken in conjunction with the accompanying drawings, wherein:

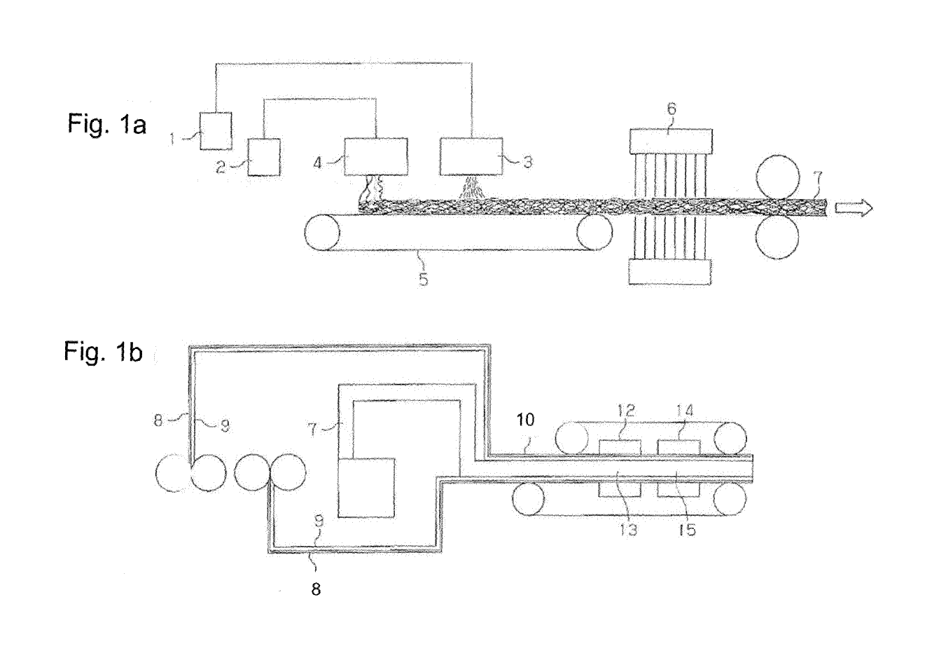

FIG. 1 (a) is a side view which schematically shows an equipment producing a fiber mat according to embodiment No. 1;
(b) is a side view which schematically shows an equipment producing a laminated sheet according to embodiment No. 1;

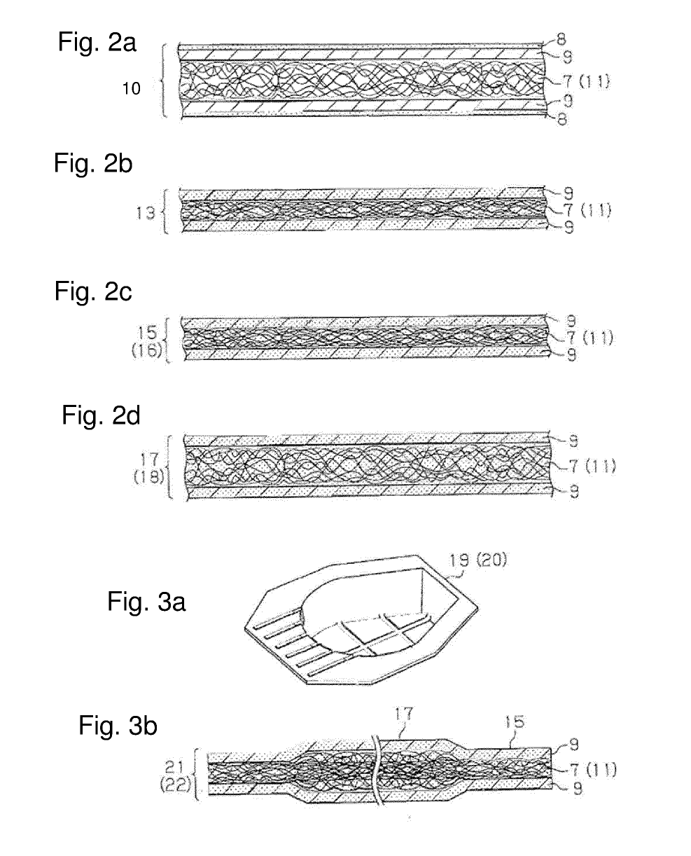

FIG. 2 (a) is a cross-section view which schematically shows the first stage sheet in a manufacturing process of a laminated sheet of embodiment No. 1;
(b) is a cross-section view which schematically shows the second stage sheet;
(c) is a cross-section view which schematically shows the third stage sheet;
(d) is a cross-section view which schematically shows the fourth stage sheet;

FIG. 3 (a) is a diagrammatic perspective view which schematically shows a compact comprising a fifth stage sheet obtained by processing a laminated sheet of embodiment No. 1;
(b) is a cross-section view of a part of the compact shown in FIG. 3(a);

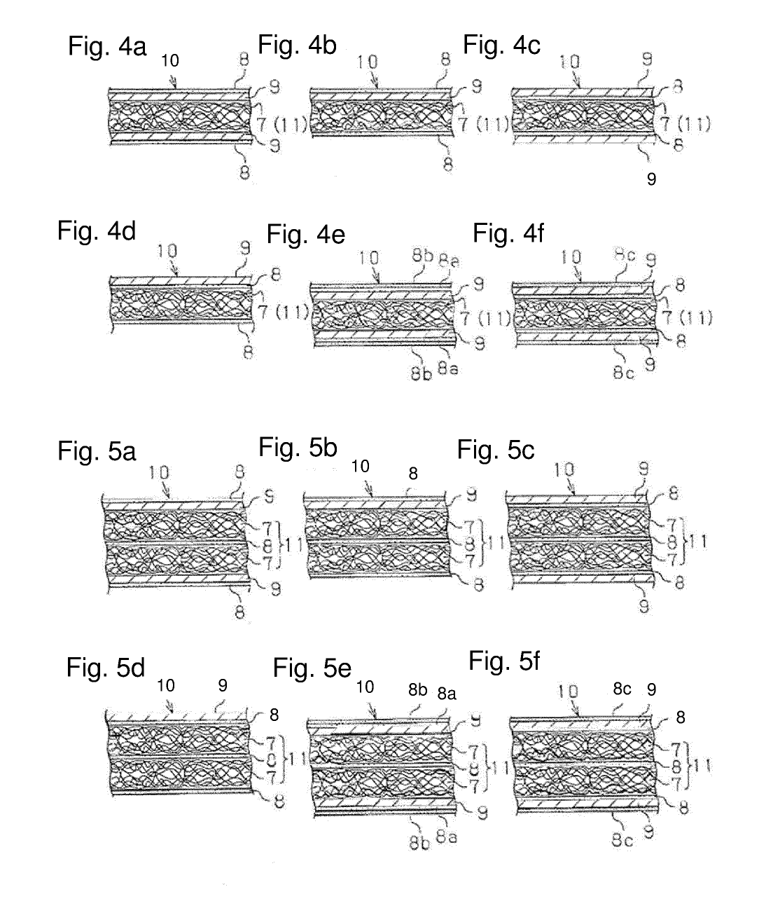

FIG. 4 (a) is a cross-section view which schematically shows the first stage sheet of embodiment No. 1;
(b) is a cross-section view which schematically shows the first stage sheet of embodiment No. 2;

(c) is a cross-section view which schematically shows the first stage sheet of embodiment No. 3;
(d) is a cross-section view which schematically shows the first stage sheet of embodiment No. 4;
(e) is a cross-section view which schematically shows the first stage sheet of embodiment No. 5;
(f) is a cross-section view which schematically shows the first stage sheet of embodiment No. 6;

FIG. 5 (a) is a cross-section view which schematically shows the first stage sheet of embodiment No. 7;
(b) is a cross-section view which schematically shows the first stage sheet of embodiment No. 8;
(c) is a cross-section view which schematically shows the first stage sheet of embodiment No. 9;
(d) is a cross-section view which schematically shows the first stage sheet of embodiment No. 10;
(e) is a cross-section view which schematically shows the first stage sheet of embodiment No. 11;
(f) is a cross-section view which schematically shows the first stage sheet of embodiment No. 12;

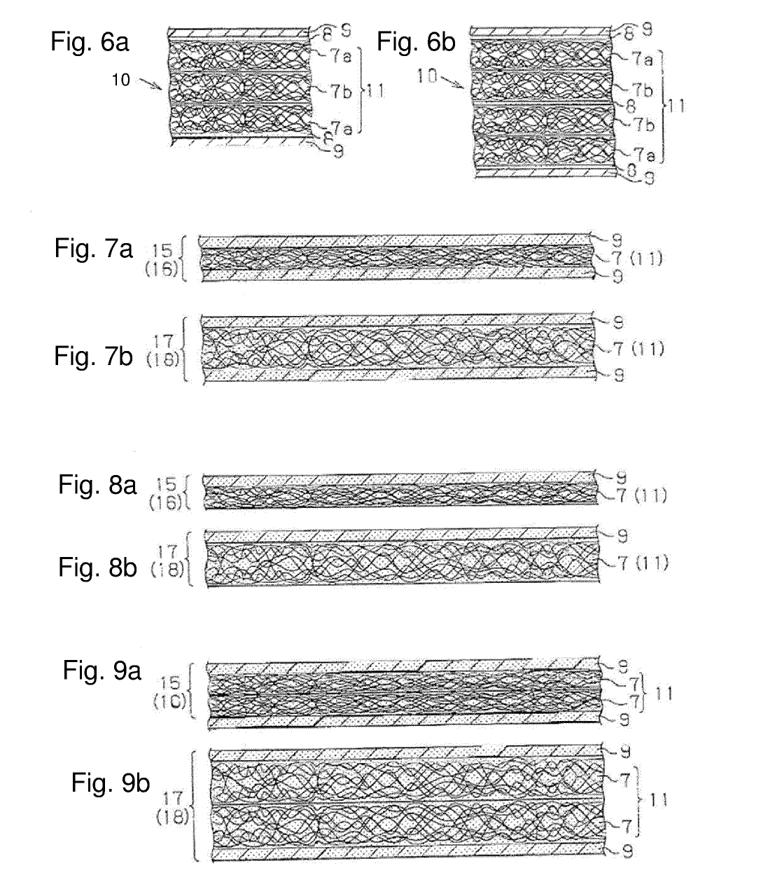

FIG. 6 (a) is a cross-section view which schematically shows the first stage sheet of embodiment No. 13;
(b) is a cross-section view which schematically shows the first stage sheet of embodiment No. 14;

FIG. 7 (a) is a cross-section view which schematically shows the second and third stage sheets of No. 1, 3, 5 and 6 embodiments;
(b) is a cross-section view which schematically shows the fourth stage sheet of embodiments No. 1, 3, 5 and 6;

FIG. 8 (a) is a cross-section view which schematically shows the second and third stage sheets of No. 2 and 4 embodiments;
(b) is a cross-section view which schematically shows the fourth stage sheet of embodiments No. 2 and 4;

FIG. 9 (a) is a cross-section view which schematically shows the second and third stage sheets of No. 7, 9, 11 and 12 embodiments;
(b) is a cross-section view which schematically shows the fourth stage sheet of No. 7, 9, 11 and 12 embodiments;

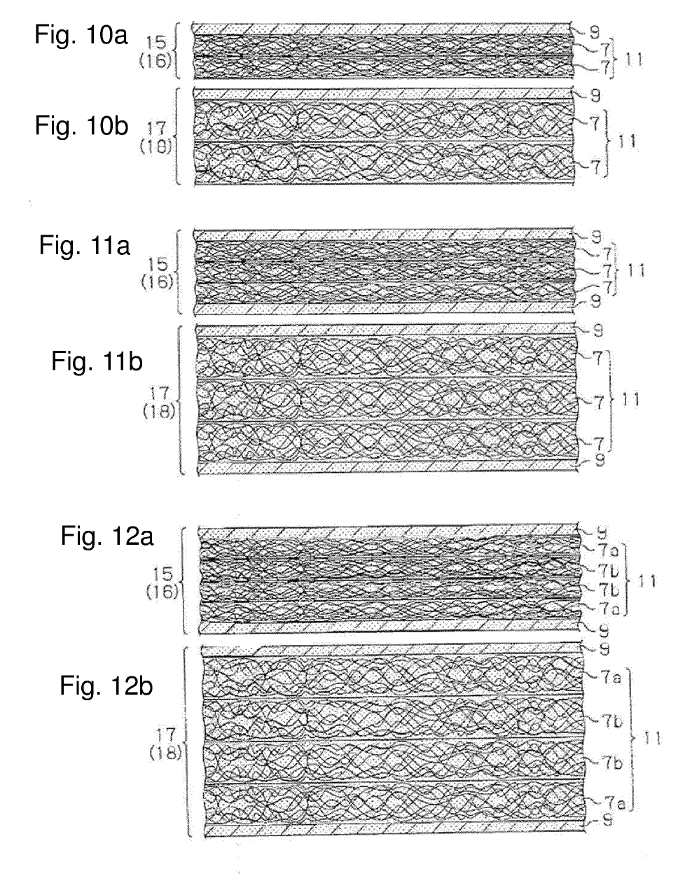

FIG. 10 (a) is a cross-section view which schematically shows the second and third stage sheets of No. 8 and 10 embodiments;
(b) is a cross-section view which schematically shows the fourth stage sheet of No. 8 and 10 embodiments;

FIG. 11 (a) is a cross-section view which schematically shows the second and third stage sheets of embodiment No. 13;
(b) is a cross-section view which schematically shows the fourth stage sheet of embodiment No. 13;

FIG. 12 (a) is a cross-section view which schematically shows the second and third stage sheets of embodiment No. 14; and
(b) is a cross-section view which schematically shows the fourth stage sheet of embodiment No. 14.

### DETAILED DESCRIPTION OF THE PREFERRED EMBODIMENTS

According to one aspect of the invention, there is provided a method for producing a flexurally rigid molded part, comprising the following steps:
a) providing a nonwoven fiber mat comprising reinforcing fibers;
b) subjecting said nonwoven fiber mat to a needling process, thereby obtaining a needled nonwoven fiber mat;
c) providing at least one thermoplastic resin sheet and at least one surface sheet, said surface sheet being formed of a non-woven cloth comprising cloth fibers, and arranging said surface sheet and said resin sheet to be substantially co-planar to said needled non-woven fiber mat, thereby obtaining a multilayered sheet, with the provision that said thermoplastic resin has a first softening temperature T1 that is lower than both a second softening temperature T2 of said cloth fibers and a third softening temperature T3 of said reinforcing fibers;
d) subjecting said multilayered sheet to a heating and pressure treatment, thereby melting said thermoplastic resin sheet so as to form a fully impregnated laminated sheet;
e) subjecting said fully impregnated laminated sheet to a cooling and pressure treatment, thereby solidifying said melted thermoplastic resin, so as to form a consolidated laminated sheet with a porosity not exceeding 5% by volume;
   wherein at least steps c) to e) are carried out as a continuous process; followed by the steps of:
f) providing a portion of said consolidated laminated sheet and heating the same to a temperature above said first softening temperature T1 but below said second softening temperature T2 and said third softening temperature T3, thereby melting thermoplastic resin contained in said laminated sheet portion, whereby said main body increases in thickness due to a springback action of reinforcing fibers contained therein, thereby forming a porous laminated sheet;
g) subjecting said porous laminated sheet to a hot molding process, thereby forming a hot molded part;
h) allowing said hot molded part to cool down, thereby forming a flexurally rigid molded part.

In the present context, the term “molded part” shall be used interchangeably with the term “compact”, as generally known in the field of fiber reinforced thermoplastics.

In particular, steps d) and e) can be carried out in a double band press.

In order to carry out the above process without disrupting the fibrous structures forming the mat of reinforcing fibers and the surfaces sheet, respectively, the softening temperature T1 of the thermoplastic resin must be lower than any softening temperatures T2 and T3 of the cloth fibers and reinforcing fibers, respectively. It will be understood that if any fiber material were to have a decomposition temperature Tc that is even lower than T2 or T3, it would be necessary to select a thermoplastic resin with a T1 smaller than Tc.

It will also be understood that a hot molding process, for example in a metal mold, will subject the laminated sheet contained therein to be formed into a shape defined by the distance between molding tools. That distance can be variable across the tool, so as to form local depressions and/or protruding areas in accordance with the final product to be manufactured (i.e. the compact or molded part).

It is important to note that the above defined steps e) and f) will generally be carried out at different locations and at arbitrarily different times. In particular, it is contemplated that one manufacturer will produce consolidated laminated sheets with low porosity, which basically represent a so-called “semi-finished” product. The semi-finished product can be temporarily stored and is eventually transported to another manufacturer who will carry out the molding steps f) to h) to form the final product. In this respect, it is advantageous that the semi-finished product has minimum porosity and thus minimum volume, which allows for more efficient transportation.

Just to give an informative example, a typical fully consolidated laminated sheet obtained at the end of step e) may have a thickness of 1.5 mm whereas step f) will lead to a porous sheet with a thickness of 5 mm. In the subsequent molding process g) the laminated sheet may be compressed back to typically 3 mm or, as the case may be, all the way to fully consolidated conditions with 1.5 mm thickness.

According to another aspect, there is provided a method for producing a flexurally rigid consolidated laminated sheet, comprising the following steps:
a) providing a nonwoven fiber mat comprising reinforcing fibers;
b) subjecting said nonwoven fiber mat to a needling process, thereby obtaining a needled nonwoven fiber mat;
c) providing at least one thermoplastic resin sheet and at least one surface sheet, said surface sheet being formed of a non-woven cloth comprising cloth fibers, and arranging said surface sheet and said resin sheet to be substantially co-planar to said needled non-woven fiber mat, thereby obtaining a multilayered sheet, with the provision that said thermoplastic resin has a first softening temperature T1 that is lower than both a second softening temperature T2 of said cloth fibers and a third softening temperature T3 of said reinforcing fibers;
d) subjecting said multilayered sheet to a heating and pressure treatment, thereby melting said thermoplastic resin sheet so as to form a fully impregnated laminated sheet;
e) subjecting said fully impregnated laminated sheet to a cooling and pressure treatment, thereby solidifying said melted thermoplastic resin, so as to form a consolidated laminated sheet with a porosity not exceeding 5% by volume.
   wherein at least steps c) to e) are carried out as a continuous process. This method allows production of a convenient semi-finished product as explained further above.

According to a further aspect, there is provided a flexurally rigid molded part produced by the above defined method, the molded part comprising:
a core layer made of at least one needled nonwoven fiber material comprising reinforcing fibers;
at least one surface layer attached in substantially co-planar manner to one face of said core layer, said surface layer being formed of a non-woven cloth comprising cloth fibers;
wherein gaps within and between said core layer and said surface layer are impregnated with a thermoplastic resin having a first softening temperature T1 that is lower than both a second softening temperature T2 of said cloth fibers and a third softening temperature T3 of said reinforcing fibers, whereby said surface layer is firmly attached to said core layer.
   said molded part having a reinforcing fiber content of 10 to 50% by weight.

According to yet another aspect, there is provided a flexurally rigid consolidated laminated sheet produced by the above defined method, the laminated sheet comprising:
a main body made of at least one needled nonwoven fiber mat comprising reinforcing fibers;
at least one surface sheet attached in substantially co-planar manner to one face of said main body, said surface sheet being formed of a non-woven cloth comprising cloth fibers;
wherein gaps within and between said main body and said surface sheet are impregnated with a thermoplastic resin having a first softening temperature T1 that is lower than both a second softening temperature T2 of said cloth fibers and a third softening temperature T3 of said reinforcing fibers, whereby said surface sheet is firmly attached to said main body,
   said laminated sheet having an area weight of 300 to 6500 g/m², a reinforcing fiber content of 10 to 50% by weight and a porosity not exceeding 5% by volume.

In particular, the above defined consolidated laminated sheet can be used to carry out the above defined method of producing a flexurally rigid molded part.

Advantageous embodiments are defined in the dependent claims.

The needled nonwoven fiber material of the above mentioned core layer or main body, respectively, preferably comprises reinforcing fibers having an average length by weight of 25 to 100 mm, or even continuous fibers, that are uniformly distributed in the core layer or main body, respectively, and are present as individual filaments to an extent of 50% or more.

In one embodiment, the hot molding process comprises forming at least one compacted region with comparatively smaller thickness and at least one expanded region with comparatively larger thickness. Advantageously, this is accomplished by the specific profile of the mold tools. Here the term “comparatively” refers to a comparison between compacted region and expanded region. Typically, such compacted regions are used to provide structural stability whereas the expanded regions are used to provide thermal and/or acoustic insulation. In one embodiment, such an expanded region has a porosity of about 35 to about 65% by volume, whereas the compacted region will have a comparatively lower porosity which may be as low as 5% by volume or even less.

The reinforcing fibers can be of any known and suitable type, such as glass fibers, carbon fibers, aramid fibers, basalt fibers, plastic fibers, natural fibers, metal fibers, pulp fibers or any mixtures thereof. The nonwoven mat of reinforcing fibers can be configured as textile fabric or knitting other than a nonwoven cloth. Advantageously, the reinforcing fibers are selected from glass fibers and carbon fibers or a mixture thereof. These fibers have excellent mechanical and thermal stability, thus allowing to select the thermoplastic resin from a wide range.

The surface sheet can be composed of nonwoven cloths of glass fibers, carbon fibers, natural fibers, metal fibers, pulp fibers etc. other than a nonwoven cloth of plastic fibers, and can be composed of textile fabrics or knitting other than a nonwoven cloth. It can also be made from polymer fibers, for example, polypropylene, polyester, polyethylene, nylon, vinylon, rayon, acryl, aramid, polylactic acid, polyethylene terephthalate (PET), provided that the resin fibers have a softening temperature T2 that is higher than the softening temperature T1 of the thermoplastic resin.

In a particularly advantageous embodiment, the cloth fibers of the surface sheet are polyethylene terephthalate (PET) fibers. This was found to give excellent acoustic properties, for example for automotive parts. Moreover, the surface formed with such material is pleasant to the touch. Preferably, the amount of PET fibers is 5 to 50% by weight, particularly about 35 to 45% by weight in relation to the entire semifinished product.

According to a further advantageous embodiment, the thermoplastic resin is polypropylene. This allows carrying out the heating and pressure step d) at moderate temperatures around 200° C.

In a particularly advantageous embodiment, the laminated sheet has an area weight of 300 to 2500 g/m², particularly of 500 to 1800 g/m².

According to a further embodiment, at least one of the surface sheets is provided with a decorative print.

As will be explained further below, the main body of the laminated sheet, which will become the core layer of the compact produced by molding, can consist of a single fiber mat. In other embodiments, however, the main body comprises two or even more fiber mats arranged adjacent to each other. In some embodiments such fiber mats are arranged in sandwich manner with a thermoplastic resin sheet therebetween. It is also possible to have a plurality of fiber mats comprising groups of fiber mats with different properties. A similar multitude applies for the number and arrangement of surface sheets and thermoplastic resin sheets, which can be one-sided, two-sided, dual resin sheet, and so forth.

In the enclosed figures, reference numerals shown in parentheses denote semifinished or finished parts made of certain layers, with the latter denoted by reference numerals without parentheses.

To begin, embodiment No. 1 of the invention is explained by referring to FIGS. 1 to 3. As FIG. 1 (a) shows, glass fibers extracted from a chopped glass fiber container 1 and a continuous glass fiber container 2 are fed as chopped glass fibers from a chopped type feeding device 3 and as continuous glass fibers from a continuous type feeding device 4 onto a net conveyor 5. Subsequently, they are subjected to two-sided needle punching in a needle punching apparatus 6 and are carried out as fiber mats of nonwoven cloth 7. In other embodiments not shown here, only chopped glass fiber or only continuous glass fibers are used.

In the present embodiment as well as in any other embodiments, the fiber mats of the nonwoven cloth can be composed of glass fibers only (inorganic fibers), or they can be composed of carbon fibers, aramid fibers, basalt fibers, plastic fibers, natural fibers, metal fibers, pulp fibers etc. other than glass fibers or mixtures thereof, and they can be configured as textile fabrics or knittings other than a nonwoven cloth. In a general context, such fibers will also be called “reinforcing fibers”.

As the FIG. 1 (b) shows, a pair of surface sheets of nonwoven cloth 9 and the above described fiber mat 7 are combined to form the first stage sheet 10 which the FIG. 2 (a) shows. In this embodiment, each surface sheet 9 is provided at the side thereof facing away from the fiber mat 7 with a respective thermoplastic resin sheet 8. Accordingly, the fiber mat 7 is between surface sheets 9 and one thermoplastic resin sheet 8 is provided on each outer side of surface sheets 9, so that the fiber mat 7 and surface sheets 9 are between thermoplastic resin sheets 8. The thermoplastic resin sheet has a first softening temperature T1.

The first stage sheet 10 is then subjected to heating and pressure treatment when passing through a heating pressure zone 12, as the FIG. 2 (b) shows. This causes the thermoplastic resin sheets 8 to melt and leads to formation of the second stage sheet 13, wherein substantially each gap of the fiber mat 7 and the surface sheets 9 is impregnated with thermoplastic resin.

Thereafter the second stage sheet 13 is subjected to a cooling treatment when passing through a cooling pressure zone 14, as the FIG. 2 (c) shows. Thereby thermoplastic resin becomes solidified in each gap of the fiber mat 7 and surface sheets 9. This leads to formation of a fully consolidated laminated sheet 16, i.e. to a third stage sheet 15 wherein both surface sheets 9 are firmly attached to the respective outer sides of fiber mat 7. In the third stage sheet 15 the fiber mat 7 is thinner than the fiber mat 7 of the first stage sheet 10 shown in FIG. 2 (a).

In the present embodiment as well as in any other emobodiments, any surface sheet 9 can be composed of nonwoven cloths of glass fibers, carbon fibers, natural fibers, metal fibers, pulp fibers etc. other than a nonwoven cloth of plastic fibers, and can be composed of textile fabrics or knitting other than a nonwoven cloth. It can also be made from polymer fibers, for example, polypropylene, polyester, polyethylene, nylon, vinylon, rayon, acryl, aramid, polylactic acid, polyethylene terephthalate (PET), provided that the resin fibers have a second softening temperature T2 that is higher than the first softening temperature T1 of the thermoplastic resin sheet 8. This is to ensure that the form of a surface sheet 9 can be kept even if the thermoplastic resin sheet 8 melts and each gap of the fiber mat 7 and a surface sheet 9 is impregnated with thermoplastic resin. For this purpose, the thermoplastic resin sheet 8 is molded by a resins selected from, for example, polypropylene, polyethylene, polyamide, polyester etc.

When subjecting a laminated sheet 16 of the third stage sheet 15 to a heating treatment, as the FIG. 2 (d) shows, thermoplastic resin solidified in each gap of the fiber mat 7 and the surface sheet 9 melts, whereby fiber mat 7 re-expands by springback of the reinforcing fibers contained therein. By this springback or “loft” effect, the porosity of the fiber mat 7 increases and becomes larger than the porosity of the surface sheets 9. After that, the thermoplastic resin is allowed to solidify by natural cooling in each gap of the fiber mat 7 and the surface sheet 9. This results in a laminated sheet 18 formed by a fourth stage sheet 17. The fourth stage sheet 17 is thicker than the third stage sheet 15, for example more than twice as thick.

As the FIG. 3 (a) shows, when a laminated sheet 16 or 18, which are formed by a third stage sheet 15 or a fourth stage sheet 17, respectively, are molded by setting in a metal mold, they become a compact 20 formed of a fifth stage sheet 19. As the FIG. 3 (b) shows, by setting a laminated sheet 18 formed by a fourth stage sheet 17 in a metal mold and subjecting only one part of the laminated sheet 18, for example the whole peripheral lines thereof, to a heating and pressure treatment, it becomes a compact 22 formed by a sixth stage sheet 21. Therein, the fully or partially consolidated third stage sheet 15 forms a marginal plate of the compact whereas the lofted or weakly consolidated fourth stage sheet 17 forms the inner part of the compact.

Furthermore, decorativeness of the laminated sheets 16, 18 and compacts 20, 22 can be improved by applying a color or a pattern on surface sheet 9.

In the following, embodiments No. 2 to 16 embodiments will be explained mainly by pointing out the differences from embodiment No. 1.

Regarding the first stage sheet 10 of embodiment No. 2 shown by the FIG. 4 (b), the bottom one of surface sheets 9 formed by first stage sheets 10 of embodiment No. 1 as shown in FIG. 2 (a) and identical FIG. 4 (a) is omitted. Regarding the first stage sheet 10 of embodiment No. 3 shown by the FIG. 4 (c), one piece each of thermoplastic resin sheet 8 is put on the upper and bottom sides of a piece of fiber mat 7 (main body 11), so that the fiber mat 7 is arranged between a pair of thermoplastic resin sheets 8. Furthermore, one piece each of a surface sheet 9 is put on the upper and bottom thermoplastic resin sheets 8, so that the fiber mat 7 and the thermoplastic resin sheets 8 are arranged between a pair of surface sheets 9.

Regarding the first stage sheet 10 of embodiment No. 4 shown by the FIG. 4 (d), the bottom one of surface sheets 9 of the first stage sheet 10 of embodiment No. 3 shown by the FIG. 4 (c) is omitted.

Regarding the first stage sheet 10 of embodiment No. 5 shown by the FIG. 4 (e), the thermoplastic resin sheets 8 of the first stage sheet 10 of embodiment No. 1 shown in FIG. 2 (a) and FIG. 4 (a) actually consist of two pieces of thermoplastic resin sheets 8a, 8b which are arranged on top of each other. The qualities of the two thermoplastic resin sheets 8a and 8b differ from one another. For example, thermoplastic resin sheet 8a is molded by a resin selected from polypropylene, polyethylene, polyamide, polyester etc. On the other hand, thermoplastic resin sheet 8b is molded by a resin selected from polypropylene, polyethylene, polyamide, polyester, polycarbonate, polyvinyl chloride, polystyrene, ABS resin etc.

Regarding the first stage sheet 10 of embodiment No. 6 shown by the FIG. 4 (f), one piece each of thermoplastic resin sheet 8c (thermoplastic resin film) is put on the outer side of each surface sheet 9 corresponding to the first stage sheet 10 of embodiment No. 3 shown by the FIG. 4 (c). For example, the thermoplastic resin sheet 8c (thermoplastic resin film) is molded by a resin selected from polypropylene, polyethylene, polyamide, polyester, polycarbonate, polyvinyl chloride, polystyrene, ABS resin etc. Accordingly, each surface sheet 9 is enclosed between two thermoplastic resin sheets 8 and 8c, respectively. Regarding the first stage sheet 10 of embodiment No. 7 shown by the FIG. 5 (a), a main body 11 which is the first stage sheet 10 of embodiment No. 1 shown by FIG. 2 (a) and FIG. 4 (a) actually comprises a sandwich formed of two pieces of fiber mats 7 and one piece of a thermoplastic resin sheet 8 between them.

Regarding the first stage sheet 10 of embodiment No. 8 shown by the FIG. 5 (b), one of surface sheets 9 which is the first stage sheet 10 of embodiment No. 7 shown by the FIG. 5 (a) is omitted.

Regarding the first stage sheet 10 of embodiment No. 9 shown by the FIG. 5 (c), one piece each of a thermoplastic resin sheet 8 is put on the upper and bottom sides of a fiber mat 7 of a sandwich type main body 11, which is the first stage sheet 10 of embodiment No. 7 shown by the FIG. 5 (a), so that the main body 11 is between a pair of thermoplastic resin sheets 8. Furthermore, one piece each of surface sheet 9 is put on the upper and bottom side of thermoplastic resin sheets 8, so that the fiber mats 7 of sandwich-type main body 11 and the thermoplastic resin sheets 8 are arranged between surface sheets 9.

Regarding the first stage sheet 10 of embodiment No. 10 shown by the FIG. 5 (d), one of surface sheets 9 which is the first stage sheet 10 of embodiment No. 9 shown by the FIG. 5 (c) is omitted.

Regarding the first stage sheet 10 of embodiment No. 11 shown by the FIG. 5 (e), the outer thermoplastic resin sheets 8 of the first stage sheet 10 of embodiment No. 7 shown by the FIG. 5 (a) actually consist of two pieces of thermoplastic resin sheets 8a, 8b which are arranged on top of each other. The qualities of two thermoplastic resin sheets 8a and 8b differ from one another.

Regarding the first stage sheet 10 of embodiment No. 12 shown by the FIG. 5 (f), one thermoplastic resin sheet 8c (thermoplastic resin films) each is put on the outer side of each surface sheet 9.

Regarding the first stage sheet 10 of embodiment No. 13 shown by the FIG. 6 (a), a main body 11 corresponding to the first stage sheet 10 of embodiment No. 9 shown by the FIG. 5 (c) actually consists of three pieces of fiber mats 7a, 7b, 7a which are stacked on top of each other. The qualities of both fiber mats 7a and a fiber mat 7b arranged between fiber mats 7a differ from one another. For example, a fiber mat 7b between fiber mats 7a is a nonwoven cloth which consists of chopped glass fibers or continuous glass fibers in the same way as embodiment No. 1. In contrast, fiber mats 7a are made of mixed fibers comprising other reinforcing fibers than glass fibers, for example, textile fabrics etc.

Regarding the first stage sheet 10 of embodiment No. 14 shown by the FIG. 6 (b), a main body 11 corresponding to the first stage sheet 10 of embodiment No. 9 shown by the FIG. 5 (c) actually consists of two pairs of fiber mats, each pair comprising two pieces of fiber mats 7a, 7b put on top of each other as a set. The sequence of mats is 7a, 7b, 7b, 7a with a piece of thermoplastic resin sheet 8 placed between the adjacent sides 7b of the two mat pairs. In each pair of fiber mats 7a, 7b, the qualities of the first fiber mat 7a and the other fiber mat 7b differ from each another.

The third stage sheet 15 (a consolidated laminated sheet 16) of embodiments No. 3, 5, 6 shown by the FIG. 7 (a) is the same as the third stage sheet 15 (a consolidated laminated sheet 16) of embodiment No. 1 shown by FIG. 2 (b) and FIG. 7 (a). The fourth stage sheet 17 (a lofted laminated sheet 18) of embodiments No. 3, 5, 6 shown by the FIG. 7 (b) is the same as the fourth stage sheet 17 (a lofted laminated sheet 18) of embodiment No. 1 shown by FIG. 2 (c) and FIG. 7 (b).

Regarding the third stage sheet 15 (a consolidated laminated sheet 16) of embodiments No. 2, 4 shown by the FIG. 8 (a) and the fourth stage sheet 17 (a lofted laminated sheet 18) of embodiments No. 2, 4 shown by the FIG. 8 (b), there is only one piece of surface sheet 9, which is arranged on the upper side of main body 11 (one piece of fiber mat 7).

Regarding the third stage sheet 15 (a consolidated laminated sheet 16) of embodiments No. 7, 9, 11, 12 shown by the FIG. 9 (a) and the fourth stage sheet 17 (a lofted laminated sheet 18) of embodiments No. 7, 9, 11, 12 shown by the FIG. 9 (b), one piece each of surface sheet 9 are arranged on the upper and bottom sides of main body 11 (two pieces of fiber mats 7).

Regarding the third stage sheet 15 (a consolidated laminated sheet 16) of embodiments No. 8, 10 shown by the FIG. 10 (a) and the fourth stage sheet 17 (a lofted laminated sheet 18) of embodiments No. 8, 10 shown by the FIG. 10 (b), there is only one piece of surface sheet 9, which is arranged on the upper side of main body 11 (two pieces of fiber mats 7).

Regarding the third stage sheet 15 (a consolidated laminated sheet 16) of embodiment No. 13 shown by the FIG. 11 (a) and the fourth stage sheet 17 (a lofted laminated sheet 18) of embodiment No. 13 shown by the FIG. 11 (b), one piece each of surface sheet 9 are arranged on the upper and bottom sides of main body 11 (three pieces of fiber mats 7a, 7b, 7a).

Regarding the third stage sheet 15 (a consolidated laminated sheet 16) of embodiment No. 14 shown by the FIG. 12 (a) and the fourth stage sheet 17 (a lofted laminated sheet 18) of embodiment No. 14 shown by the FIG. 12 (b), one piece each of surface sheet 9 are arranged on the upper and bottom sides of main body 11 (four pieces of fiber mats 7a, 7b, 7b, 7a).

The above embodiments have the following effects:
1. Regarding the laminated sheets 16, 18 and compacts 20, 22, because each of the gaps inside the main body 11 mainly composed of fiber mats 7, 7a, 7b mainly composed of a glass fiber and the surface sheets 9 of a nonwoven cloth are impregnated with thermoplastic resins, the strength of laminated sheets 16, 18 and compacts 20, 22 can be increased. Moreover, any surface sheets 9 put on the outer side of fiber mats 7, 7a, 7b of the main body 11 makes the appearance better and is pleasant to the touch. Furthermore, thermoplastic resin impregnated in the gap of fiber mats 7, 7a, 7b of the main body 11 and thermoplastic resin impregnated in the gap of any surface sheets 9 are linked to each other, therefore the adhesive strength of each surface sheet 9 against the outer side of fiber mats 7, 7a, 7b of the main body 11 can be increased and its nondetachability can be improved.
2. Regarding the laminated sheet 18, because thin films and fine holes are formed on each surface sheet 9 of nonwoven cloth impregnated with thermoplastic resin, particularly a low-frequency portion of incident sound decreases by energy conversion action generated when incident sound colliding with a surface sheet 9 generates vibration of a thin film or passes through fine holes. In addition, regarding laminated sheet 18, because a porous section appears on main body 11 comprising fiber mats 7, 7a, 7b impregnated with thermoplastic resin, particularly middle- and high-frequency portions of incident sound decrease by energy conversion action generated when incident sound passing through a surface sheet 9 passes through the porous section. Therefore, the sound absorbency of a laminated sheet 18 can be increased. By using such a laminated sheet 18, the sound absorbency of molded compacts 20, 22 can be also increased.
3. The tensile strength of consolidated laminated sheet 16 (the third stage sheet 15) is higher compared with that of a lofted laminated sheet 18 (the fourth stage sheet 17). Therefore, depending on the specific application, it is possible to have highly consolidated, low-porosity regions of higher tensile strength and unconsolidated or weakly consolidated, high-porosity regions of higher structural stiffness and good acoustic properties; these regions can be defined by the molding process, particularly by the geometry of the molding tools.

Except for the embodiments described above, further embodiments are possible. For example, the main body 11 can be composed of fiber mats 7, 7a, 7b, only, or it can be obtained by putting onto fiber mats 7, 7a, 7b at least one further mat whose quality is different therefrom.

### LIST OF REFERENCE NUMERALS

1 chopped reinforcing fiber supply

2 continuous reinforcing fiber supply

3 chopped type feeding device

4 continuous type feeding device

5 net conveyor

6 needling and punching apparatus

7, 7a, 7b fiber mat

8, 8a, 8b, 8c thermoplastic resin sheet

9 surface sheet

10 first stage sheet

11 main body

12 heating pressure zone

13 second stage sheet

14 cooling pressure zone

15 third stage sheet

16 laminated sheet (compressed, consolidated)

17 fourth stage sheet

18 laminated sheet (reexpanded, lofted)

19 fifth stage sheet

20 compact=molded part

21 sixth stage sheet

22 section of compact=molded part

1-18. (canceled)

19. A method for producing a flexurally rigid molded part, comprising the following steps:
a) providing a nonwoven fiber mat comprising reinforcing fibers;
b) subjecting said nonwoven fiber mat to a needling process, thereby obtaining a needled nonwoven fiber mat;
c) providing at least one thermoplastic resin sheet and at least one surface sheet, said surface sheet being formed of a non-woven cloth comprising cloth fibers, and arranging said surface sheet and said resin sheet to be substantially co-planar to said needled non-woven fiber mat, thereby obtaining a multilayered sheet, with the provision that said thermoplastic resin has a first softening temperature T1 that is lower than both a second softening temperature T2 of said cloth fibers and a third softening temperature T3 of said reinforcing fibers;
d) subjecting said multilayered sheet to a heat and pressure, thereby melting said thermoplastic resin sheet so as to form a fully impregnated laminated sheet;
e) subjecting said fully impregnated laminated sheet to cooling under pressure, thereby solidifying said melted thermoplastic resin, so as to form a consolidated laminated sheet with a porosity not exceeding 5% by volume;
wherein at least steps c) to e) are carried out as a continuous process;
followed by the steps of:
f) providing a portion of said consolidated laminated sheet and heating the portion to a temperature above said first softening temperature T1 but below said second softening temperature T2 and said third softening temperature T3, thereby melting thermoplastic resin contained in said laminated sheet portion, whereby said consolidated laminated sheet increases in thickness due to a springback action of reinforcing fibers contained therein, thereby forming a porous laminated sheet;
g) subjecting said porous laminated sheet to a hot molding process, thereby forming a hot molded part;
h) allowing said hot molded part to cool down, thereby forming a flexurally rigid molded part.

20. The method of claim 19, wherein said hot molding process comprises forming at least one compacted region with comparatively smaller thickness and at least one expanded region with comparatively larger thickness relative to each other.

21. A method for producing a flexurally rigid consolidated laminated sheet, comprising the following steps:
a) providing a nonwoven fiber mat comprising reinforcing fibers;
b) subjecting said nonwoven fiber mat to a needling process, thereby obtaining a needled nonwoven fiber mat;
c) providing at least one thermoplastic resin sheet and at least one surface sheet, said surface sheet being formed of a non-woven cloth comprising cloth fibers, and arranging said surface sheet and said resin sheet to be substantially co-planar to said needled non-woven fiber mat, thereby obtaining a multilayered sheet, with the provision that said thermoplastic resin has a first softening temperature T1 that is lower than both a second softening temperature T2 of said cloth fibers and a third softening temperature T3 of said reinforcing fibers;
d) subjecting said multilayered sheet to a heat and pressure, thereby melting said thermoplastic resin sheet so as to form a fully impregnated laminated sheet;
e) subjecting said fully impregnated laminated sheet to cooling under pressure, thereby solidifying said melted thermoplastic resin, so as to form a consolidated laminated sheet with a porosity not exceeding 5% by volume.
wherein at least steps c) to e) are carried out as a continuous process.

22. The method of claim 19, wherein said reinforcing fibers are glass fibers, carbon fibers, or a mixture thereof.

23. The method of claim 21, wherein said reinforcing fibers are glass fibers, carbon fibers, or a mixture thereof.

24. The method of claim 19, wherein said cloth fibers of said surface sheet comprise polyethylene terephthalate fibers.

25. The method of claim 21, wherein said cloth fibers of said surface sheet comprise polyethylene terephthalate fibers.

26. The method of claim 19, wherein said thermoplastic resin is polypropylene.

27. The method of claim 21, wherein said thermoplastic resin is polypropylene.

28. A flexurally rigid molded part, prepared by the method of claim 19, comprising:
a) a core layer of at least one needled nonwoven fiber material comprising reinforcing fibers having first and second faces;
b) at least one surface layer substantially co-planar to one face of said core layer, said surface layer formed of a non-woven cloth comprising cloth fibers;
wherein gaps within and between said core layer and said surface layer are impregnated with a thermoplastic resin having a first softening temperature T1 that is lower than both a second softening temperature T2 of said cloth fibers and a third softening temperature T3 of said reinforcing fibers, whereby said surface layer is firmly attached to said core layer.
said molded part having a reinforcing fiber content of 10 to 50% by weight.

29. The flexurally rigid molded part of claim 28, comprising at least one compacted region with comparatively smaller thickness and at least one expanded region with comparatively larger thickness relative to each other, said expanded region having a porosity of about 35 to about 65% by volume.

30. The molded part of claim 28, wherein said reinforcing fibers are glass fibers, carbon fibers, or a mixture thereof.

31. The molded part of claim 28, wherein said cloth fibers of said surface layer are polyethylene terephthalate fibers.

32. The molded part of claim 28, wherein said thermoplastic resin is polypropylene.

33. The molded part of claim 28, wherein at least one surface sheet is provided with a decorative print.

34. A flexurally rigid consolidated laminated sheet, obtained by the method of claim 21, comprising:
a) a main body comprising at least one needled nonwoven fiber mat comprising reinforcing fibers and having first and second faces;
b) least one surface sheet substantially co-planar to at least one face of said main body, said surface sheet comprising a non-woven cloth comprising cloth fibers;
wherein gaps within and between said main body and said surface sheet are impregnated with a thermoplastic resin (8) having a first softening temperature T1 that is lower than both a second softening temperature T2 of said cloth fibers and a third softening temperature T3 of said reinforcing fibers, whereby said surface sheet is firmly attached to said main body,
said laminated sheet having an area weight of 300 to 6500 g/m², a reinforcing fiber content of 10 to 50% by weight and a porosity not exceeding 5% by volume.

35. The laminated sheet of claim 34, wherein said laminated sheet has an area weight of 300 to 2500 g/m².

36. The laminated sheet of claim 34, wherein said laminated sheet has an area weight of 500 to 1800 g/m².

37. The laminated sheet of claim 34, wherein said reinforcing fibers are glass fibers, and carbon fibers, or a mixture thereof.

38. The laminated sheet of claim 34, wherein said cloth fibers of said surface sheet comprise polyethylene terephthalate fibers.

39. The laminated sheet of claim 34, wherein said thermoplastic resin is polypropylene.

40. The laminated sheet of claim 34, wherein at least one of said surface sheets is provided with a decorative print.
